(19) United States
(12) Patent Application Publication
(10) Pub. No.: US 2019/0276293 A1
(43) Pub. Date: Sep. 12, 2019

(54) JAR LID OPENER

(71) Applicant: Marc Klein, Mackay, ID (US)

(72) Inventor: Marc Klein, Mackay, ID (US)

(21) Appl. No.: 15/915,338

(22) Filed: Mar. 8, 2018

(51) Int. Cl. B67B 7/18

(52) U.S. Cl. CPC B67B 7/18

(57) ABSTRACT

A jar lid opener that includes: a base; a first brace attached to the base; a second brace attached to the base, where the first brace abuts the second brace on the base; an opening formed between the first brace and second brace, wherein the opening is adapted to receive a jar lid; and a means to securely brace the jar lid on the first brace. The means to securely brace the jar lid preferably includes a pair of serrated blades. In one particular embodiment, the base forms a semi-circle and an angle forms between the first brace and second brace.

### BACKGROUND OF THE INVENTION

### Field of Invention

The present invention relates to a lid opener which may be mounted under a cabinet surface.

### Description of Related Art

Many jars and bottles come with screw-on tops for access to the contents therein. Many times the screw-on tops relate to food or edible products that may come in a jar. These jars normally are vacuum sealed with a tight fit to ensure freshness of the product within. Further, releasing the initial seal on the jar is typically a difficult task. The jar's lid can be sealed quite tight and typically it is difficult for many individuals to release the initial seal. Some individuals use can openers or other things to pry the lid to initiate the release of the lid off a jar. Others may use rubber wraps that are used to wrap around the lid but still require manual force to release the lid. Still other tools have been developed to assist the individual in releasing the lid from a jar. As such it would still be imperative or beneficial to have a mounted jar opener that allows an individual to easily mount the jar into a opening and then use light manual twisting to release the lid from the jar.

### SUMMARY OF THE INVENTION

The present invention relates to a jar lid opener that includes: a base; a first brace attached to the base; a second brace attached to the base, where the first brace abuts the second brace on the base; an opening formed between the first brace and second brace, wherein the opening is adapted to receive a jar lid; and a means to securely brace the jar lid on the first brace. The means to securely brace the jar lid preferably includes a pair of serrated blades. In one particular embodiment, the base forms a semi-circle and an angle forms between the first brace and second brace.

### BRIEF DESCRIPTION OF DRAWINGS

FIG. 1 depicts a top view of the jar lid opener in accordance with the present invention.

FIG. 2 depicts a rear view of the jar lid opener according to the present invention.

FIG. 3 depicts a perspective view of the jar lid opener in accordance with the present invention.

FIG. 4 depicts a side view into the inside edge of the jar lid opener showing two dual blades on one side of the jar opener.

FIG. 5 shows yet another perspective view where the dual blades are more clearly shown on the blade side of the jar lid opener according to the present invention.

### DETAILED DESCRIPTION

The present invention provides a jar opener that is mountable on the undersurface of a cabinet or other flat surface that includes an opening to receive a lid of a jar. This opening is a V-shaped which is mounted on a semicircular base. The V-shape opening is created by using a first lid brace and a second lid brace that are attached to the base of the opener. A receiving opening is created to receive the lid and brace the lid against a blade. The blade is provided on the first lid brace and therefore secures the lid into a stationary position while an individual may turn the jar preferably using two hands to loosen the lid on the jar. The present invention includes openings in the base to mount the base onto the surface and screws are used to mount the respective braces in place onto the base of the jar lid opener.

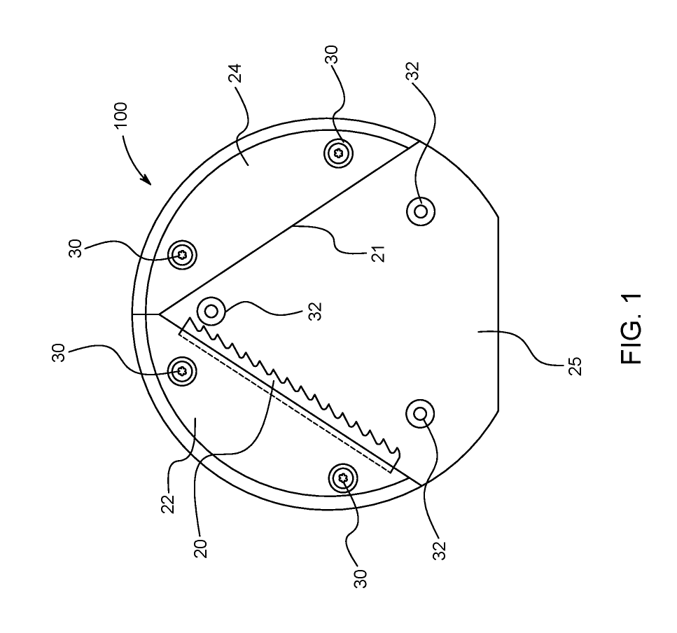

A jar lid opener 100 according to present invention is depicted in FIGS. 1-5, where FIG. 1 shows a top view of the jar lid opener 100. In this top view, a first lid brace 22 is shown and a second lid brace 24 is shown abutting the first lid brace 22 both of which are mounted on a base below each brace. Mounting Screws 30 are shown that are used to secure the braces 22, 24 to a base. The braces 22, 24 form an opening 25 that receives a jar lid. The lid brace 22 includes a pair of serrated blades 20. These serrated blades 20 are preferably made from hardened steel. The serrated blades 20 provide a means to brace a lid of a jar after being placed into the opening 25. The brace 24 includes an abutting edge 21 to support the jar lid into place while opening. Holes 32 are provided within the base to receive screws that allow the base to be mounted on the underside of a kitchen cabinet. Once in place a user places the lid within the opening 25, braces the lid against blades 20 and turns the jar to release the lid. The angle between lid brace 22 and lid brace 24 is preferably 70 degrees which provides an optimum angle to allow the lid to open with less force as opposed to the prior art.

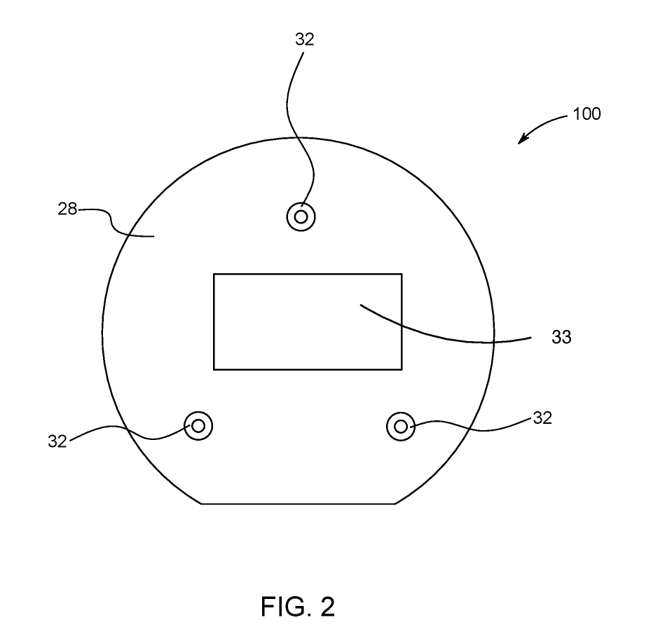

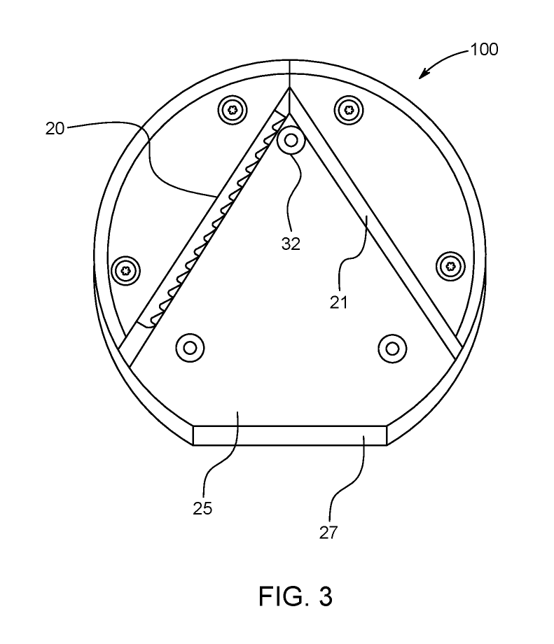

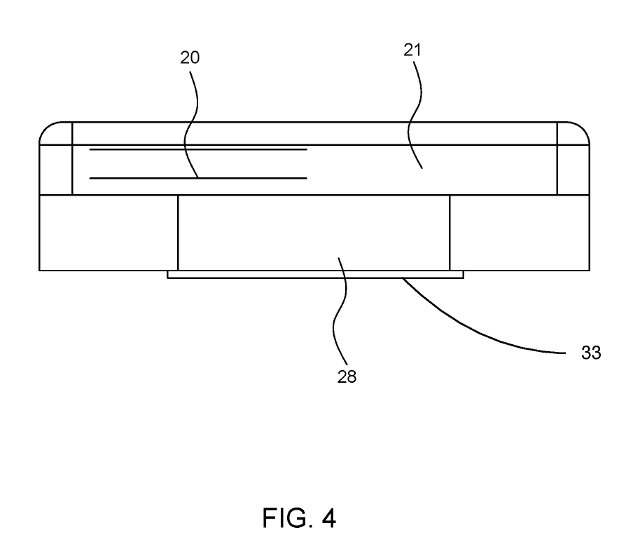

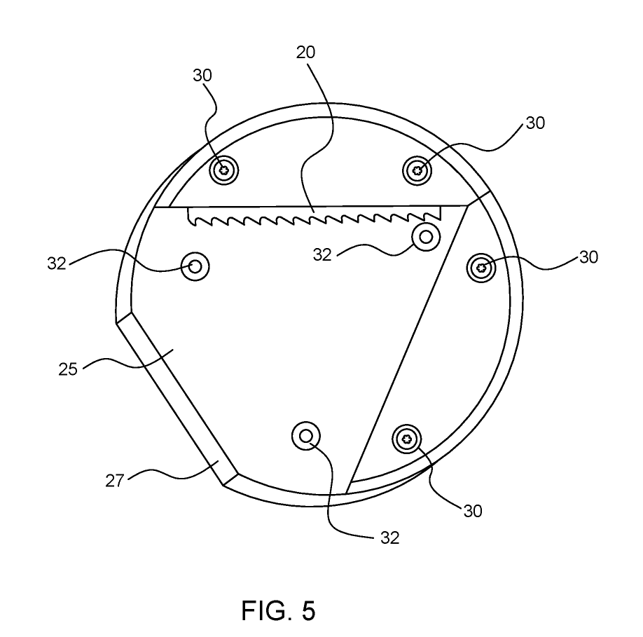

FIG. 2 is a rear view of the lid opener 100, where holes 32 are shown for mounting, where double stick tape 33 is attached to the base to aid in mounting the jar opener to the underside of a cabinet. A perspective view the pair of serrated blades 20 are clearly shown in FIGS. 3 and 5 with the opening 25 provided between the two lid braces 22, 24. A flat edge 27 is also shown in FIG. 3 with the remaining edge being substantially circular. FIG. 4 shows a side view direct toward the blades 20 and abutting edge 21. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A jar lid opener comprising:
a. a base;
b. a first brace attached to the base;
c. a second brace attached to the base, where the first brace abuts the second brace on the base;
d. an opening formed between the first brace and second brace, wherein the opening is adapted to receive ajar lid; and
e. a means to securely brace the jar lid on the first brace.

2. The jar lid according to claim 1, where the means to securely brace the jar includes a pair of serrated blades and an abutting edge.

3. The jar lid according to claim 1, where the base forms a semi circle.

4. The jar lid according to claim 1, where an angle forms between the first brace and second brace.

5. The jar lid according to claim 4, where the angle is 70 degrees.

6. The jar lid according to claim 2, where the serrated blades are made of hardened steel.
